(19) United States
(12) Patent Application Publication
(10) Pub. No.: US 2025/0124911 A1
(43) Pub. Date: Apr. 17, 2025

(54) AUDIO CANCELLATION

(71) Applicant: Nokia Technologies Oy, Espoo (FI)

(72) Inventors: Miikka Tapani VILERMO, Tampere (FI); Marja Pauliina Salmimaa, Tampere (FI); Tero Simo IIari Jokela, Tampere (FI)

(21) Appl. No.: 18/903,695

(22) Filed: Oct. 1, 2024

(30) Foreign Application Priority Data
Oct. 16, 2023 (GB) 2315771.2

(51) Int. Cl. G10K 11/178

(52) U.S. Cl. CPC G10K 11/17837; G10K 11/17853

(57) ABSTRACT

An apparatus comprising:
means for sensing user movement, wherein the sensing of user movement produces sensing data;
means for classifying the user movement, in dependence upon at least the sensing data, as a sound-producing user gesture of a user; and
means for providing audio feedback to the user in dependence upon the classification.

### TECHNOLOGICAL FIELD

Examples of the disclosure relate to audio cancellation.

### BACKGROUND

Active noise cancellation (ANC) estimates the noise that would reach a listener's ear and adapts the audio output signals to cancel that estimated noise. The noise can be estimated using a feed-forward approach that uses one or more noise signals measured using one or more exterior microphones on the same ear device and/or using a feed-back approach that uses one or more noise signals measured using one or more interior microphones of the same ear device.

It is possible to adapt active noise cancellation (ANC) which attempts to fully suppress exterior sounds and prevents them reaching a listener's ear, to achieve active audio cancellation which selectively suppresses exterior sounds and prevents some but not necessarily all exterior sounds reaching a listener's ear. This can prevent some exterior sounds reaching a user's ear while allowing other exterior sounds to ‘pass-through’ and reach the user's ear.

For example, an adjustable own voice mode can let a user change how much of their own voice passes through and reaches a user's ear.

For example, an adjustable transparency mode can let a user change how much exterior audio passes through to the user e.g. how much attenuation/cancelling there is. This can allow a user to switch from hearing no exterior sound to hearing exterior sound at a controlled level.

### BRIEF SUMMARY

Currently when there is active noise cancellation (full cancellation) or active audio cancellation (partial or selective cancellation) a user does not hear or clearly hear a sound made by a sound-producing 104 user gesture because the sound is wholly or partially cancelled.

According to various, but not necessarily all, examples there is provided an apparatus comprising:
means for sensing user movement, wherein the sensing of user movement produces sensing data;
means for classifying the user movement, in dependence upon at least the sensing data, as a sound-producing user gesture of a user; and
means for providing audio feedback to the user in dependence upon the classification. In some but not necessarily all examples, the means for providing audio feedback to the user in dependence upon the classification comprises means for temporarily modifying an audio cancellation process applied to captured ambient audio to create ambient audio for rendering to the user.

In some but not necessarily all examples, the means for temporarily modifying the audio cancellation process applied to captured ambient audio comprises means for selectively filtering the ambient audio.

In some but not necessarily all examples, the means for temporarily modifying the audio cancellation process applied to captured ambient audio comprises at least one of:
(i) means for temporarily reducing audio cancellation for higher frequencies compared to lower frequencies to enable the user to hear a sound of the sound-producing user gesture;
(ii) means for temporarily reducing attenuation of captured ambient audio to enable the user to hear a sound of the sound-producing user gesture;
(iii) means for temporarily switching-off audio cancellation to enable the user to hear a sound of the sound-producing user gesture; or
(iv) means for providing spatially selective pass-through of an ambient audio source by selectively maintaining the ambient spatial audio source in the captured ambient audio to enable the user to hear a sound of the sound-producing user gesture.

In some but not necessarily all examples, the apparatus comprises: means for enabling a user to control the means for temporarily modifying the audio cancellation process applied to captured ambient audio.

In some but not necessarily all examples, the means for providing audio feedback to the user in dependence upon the classification comprises means for temporarily rendering to the user a virtual sound.

In some but not necessarily all examples, the means for providing audio feedback to the user in dependence upon the classification comprises means for temporarily rendering to the user the virtual sound only if, when the created ambient audio is rendered to the user, a sound of the sound-producing user gesture in the created ambient audio rendered to the user, is below a loudness threshold.

In some but not necessarily all examples, the virtual sound is a sound selected from a database of virtual sounds in dependence upon the classification.

In some but not necessarily all examples, the apparatus comprises: means for enabling a user to control the extent to which the provision of audio feedback to the user in dependence upon the classification is based upon:
modifying the audio cancellation process applied to captured ambient audio to create ambient audio rendered to the user; and
rendering to the user a virtual sound.

In some but not necessarily all examples, the apparatus comprises: means for determining a direction towards the sensed user movement classified as a sound-producing user gesture; and
wherein the means for providing audio feedback to the user in dependence upon the classification
provide audio feedback as spatial audio aligned with the determined direction.

In some but not necessarily all examples, the means for providing the audio feedback to the user is configured for conditional operation and provides audio feedback to the user if the user movement is classified based upon at least the sensing data as a sound-producing user gesture and does not provide audio feedback to the user if the user movement, is not classified based upon at least the sensing data as a sound-producing user gesture.

In some but not necessarily all examples, the apparatus comprises: means for classifying the user movement, in dependence upon at least the sensing data using a trained machine learning classification algorithm.

In some but not necessarily all examples, the means for sensing user movement, comprises an optical sensor.

In some but not necessarily all examples, the apparatus comprises: means for applying a first audio cancellation process on captured ambient audio to create ambient audio for remote rendering; and
means for applying the first audio cancellation process on captured ambient audio to create ambient audio for local rendering to the user;
wherein the means for providing audio feedback to the user in dependence upon the classification comprises means for temporarily modifying the first audio cancellation process applied to captured ambient audio to create ambient audio for local rendering to the user.

In some but not necessarily all examples, the apparatus is configured as a head-worn apparatus, an in-ear apparatus, an on-ear apparatus or an over-ear apparatus.

According to various, but not necessarily all, examples there is provided a method comprising:
sensing a user movement, wherein the sensing of the user movement produces sensing data;
classifying the user movement, in dependence upon at least the sensing data, as a sound-producing user gesture of a user; and
providing audio feedback to the user in dependence upon the classification.

According to various, but not necessarily all, examples there is provided an a computer program comprising instructions that when executed by one or more processors enable an apparatus to:
classifying a sensed user movement, in dependence upon at least sensing data, as a sound-producing user gesture of a user; and providing audio feedback to the user in dependence upon the classification.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

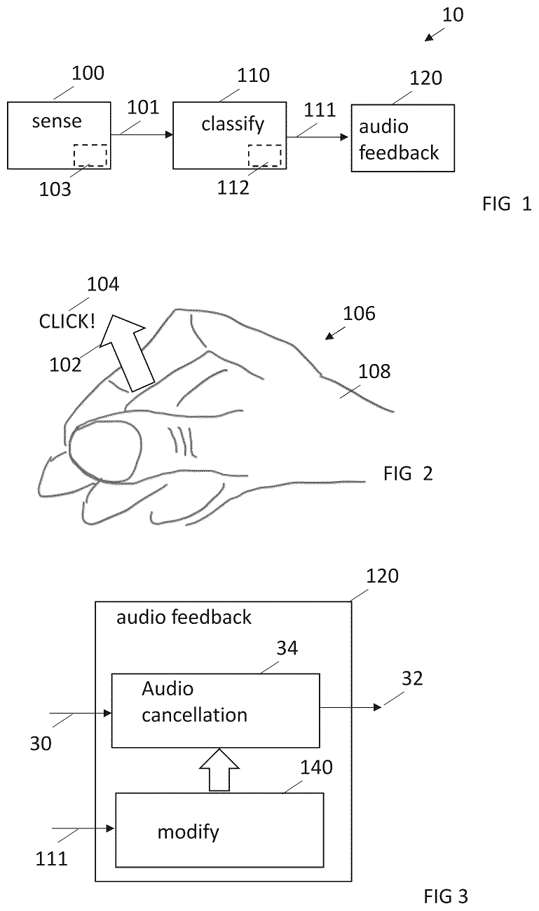

FIG. 1 shows an example of an apparatus 10 that senses 100 user movement, classifies 110 the user movement as a sound-producing user gesture and provides audio feedback 120 to the user in dependence upon the classification 111.

FIG. 2 illustrates an example of a user movement 102 that provides a recognizable user gesture 106 that makes a sound 104; 5 FIG. 3 shows an example of an apparatus 10 that modifies 140 audio cancellation 34 in dependence upon the classification 111 to provide at least some of the audio feedback 120 to the user in dependence upon the classification 111;

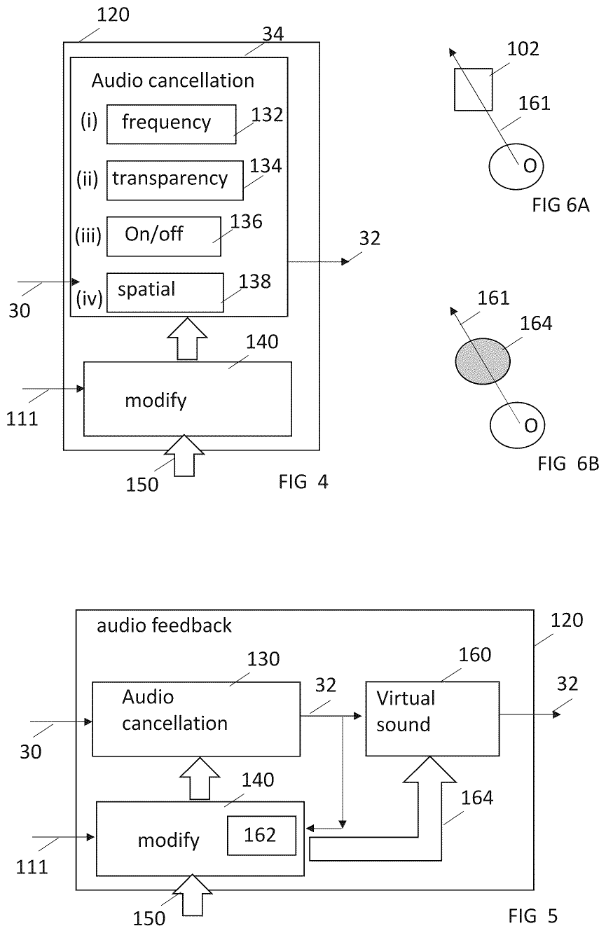

FIG. 4 shows an example of an apparatus 10 that modifies 140 audio cancellation 34 according to one or more different options in dependence upon the classification 111 to provide at least some of the audio feedback 120 to the user;

FIG. 5 shows an example of an apparatus 10 that adds a virtual sound in dependence of the classification 111 to provide at least some of the audio feedback 120 to the user;

FIG. 6A illustrates determination of a direction 161 towards the sensed user movement 102 classified as a sound-producing 104 user gesture 106 and FIG. 6B illustrates the provision of audio feedback 120 to the user in dependence of the classification 111 where the audio feedback is aligned with the determined direction 161;

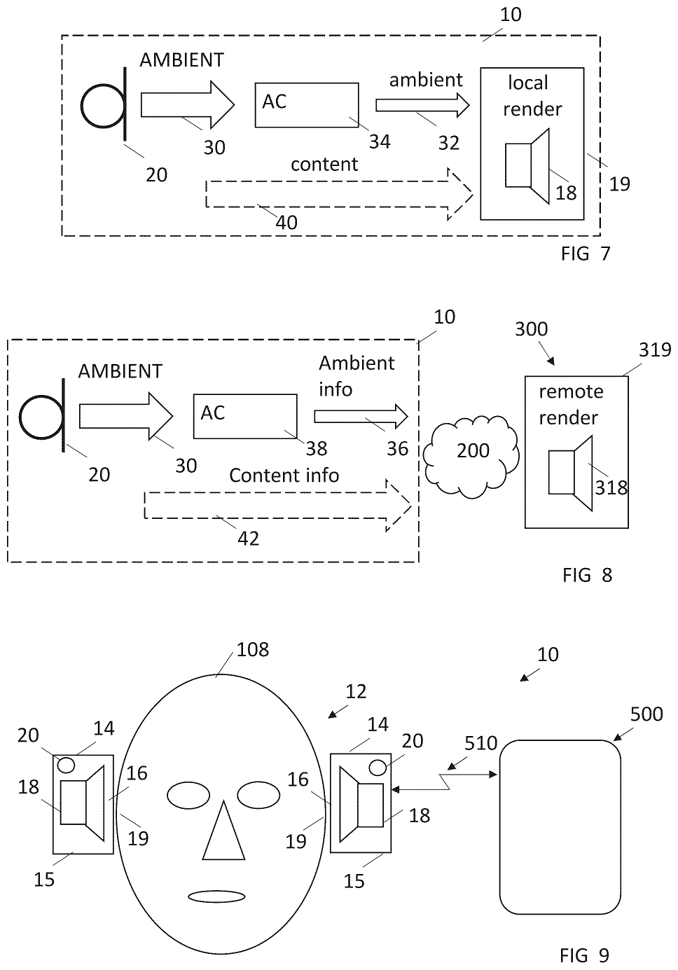

FIG. 7 shows an example of an apparatus 10 operating to render locally 19 content 40 and ambient audio 32;

FIG. 8 shows an example of the apparatus 10 operating to control 36, 42 remote rendering 319 of content and ambient audio that has a correspondence to the content 40 and ambient audio 32 rendered locally 19;

FIG. 9 shows an example of the apparatus 10 configured as a head-worn apparatus 12 that communicates with a local apparatus 500 which communicates with a remote apparatus;

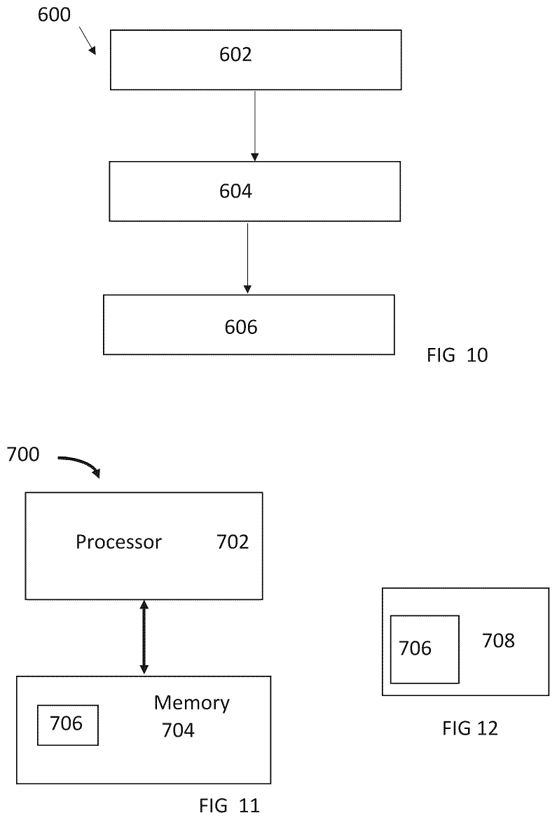

FIG. 10 shows an example of a method 600 operating to sense user movement, classify the user movement as a sound-producing 104 user gesture 106; and provide audio feedback to the user in dependence upon the classification;

FIG. 11 shows an example of controller suitable for causing performance of the method 600 and for use by the apparatus 10;

FIG. 12 shows an example of computer program 706 suitable for causing performance of the method 600.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### Definitions

Apparatus is equipment for performance of a task. An apparatus can be a unitary apparatus that is equipment that is contained within a single housing. An apparatus can be a non-unitary apparatus that is not contained within a single housing, and may be contained within multiple housing that are physically or wirelessly interconnected.

Audio refers to sound audible to a human. The term audio is used irrespective of the format of sound, which can for example be pressure waves, an electrical signal that can be transduced to produce sound or information that can be used to render sound.

Render when applied to audio means producing sound or producing a format readily convertible to sound.

Audio cancellation refers to a removal of audio by electronic processing. This can be achieved, for example, using digital signal processing.

Capturing means recording to a format that can be subsequently used.

Ambient refers to immediate surroundings. Ambient audio refers to sound that is or could be heard by a person at a particular location. The source of the sound does not need to be proximal to the user but sound needs to reach the person.

User is a person using an apparatus.

Spatial audio describes the rendering of sound sources at different controllable directions relative to a listener.

### DETAILED DESCRIPTION

The following description relates to various examples of an apparatus 10 comprising: means for sensing 100 user movement 102, wherein the sensing 100 of user movement 102 produces sensing data 101;
means for classifying 110 the user movement 102, in dependence upon at least the sensing data 101, as a sound-producing 104 user gesture 106; and
means for providing audio feedback 120 to the user 108 in dependence upon the classification 111.

In at least some examples, the apparatus 10 is configured as a head-worn apparatus 10, an in-ear apparatus 10, an on-ear apparatus 10 or an over-ear apparatus 10. For example, the apparatus 10 is, in some examples, noise cancelling headphones. For example, the apparatus 10 is, in some examples, a headset for augmented reality, a headset for virtual reality or a headset for mediated reality.

FIG. 1 illustrates an example of the apparatus 10. The apparatus 10 is configured to sense 100 user movement 102. User movement is movement 102 of a user 108 of the apparatus 10, for example as illustrated in FIG. 2.

In FIG. 2 the user 108 is performing a gesture 106 that makes a sound 104 by moving (clicking) a finger and thumb together. In at least some examples the gesture 106 that makes a sound 104 is recognizable as a user input command to the apparatus 10 or another apparatus.

It should be appreciated that the user can make movements to perform a different sound-producing 104 gesture 106, such as hand-clapping, hand slapping, foot stamping, heel clicking etc.

The sensing 100 of user movement 102 produces sensing data 101.

In some examples, the apparatus comprises one or more sensors 103 for performing the sensing 100 and producing the sensing data 101. A sensor 103 that senses user movement, can be any suitable sensor. It can for example be an optical sensor, for example a camera or a light detection and ranging (LIDAR) apparatus.

The apparatus 10 is configured to classify 110 the user movement 102, in dependence upon at least the sensing data 101, as a sound-producing 104 user gesture 106.

The apparatus 10 receives the sensing data 101 as input and processes the sensing data to determine whether there is user movement 102 identified in the sensing data 101 that is expected to be sound-producing 104 user gesture 106.

In some but not necessarily all examples, the classification 110 can recognize the user gesture 106 as one or a plurality of user input commands for the apparatus 10.

The apparatus 10 is configured to provide audio feedback 120 to the user 108 in dependence upon the classification 111.

FIG. 3 illustrates an example of any of the apparatus 10 previously described. The apparatus 10 is configured to provide audio feedback 120 to the user 108 in dependence upon the classification 111 by temporarily modifying 140 an audio cancellation process 34 applied to captured ambient audio 30 to create ambient audio 32 rendered to the user 108.

The active audio cancellation selectively suppresses exterior sounds and prevents some but not necessarily all exterior sounds reaching a listener's ear. The active audio cancellation can emulate active noise cancellation by suppressing all exterior sounds however it is more flexible and can selectively suppress or maintain or enhance exterior sounds.

Active audio cancellation can prevent some exterior sounds reaching a user's ear while allowing other exterior sounds to ‘pass-through’ and reach the user's ear. It is possible to mostly or fully suppress exterior sounds and prevents them reaching a listener's ear, to achieve active noise cancellation (ANC).

Active audio cancellation estimates the ambient audio that would reach a listener's ear and adapts the audio output signals to cancel that estimated ambient audio. The ambient audio can be estimated using a feed-forward approach that uses one or more ambient audio signals measured using one or more exterior microphones on the same ear device and/or using a feed-back approach that uses one or more ambient audio signals measured using one or more interior microphones of the same ear device.

In this example, an audio cancellation process 34 is applied to captured ambient audio 30 to create ambient audio 32 rendered to the user 108. The apparatus 10 is configured to temporarily modify 140 the audio cancellation process 34 applied to the captured ambient audio 30 and thereby create different ambient audio 32 rendered to the user 108.

FIG. 4 illustrates an example of any of the apparatus 10 previously described. The apparatus 10 is configured to temporarily modify 140 the audio cancellation process 34 applied to captured ambient audio 30 by selectively filtering the captured ambient audio 30. The filtering can be selective as regards frequency and/or space.

In this example selective filtering is applied to captured ambient audio 30 to create ambient audio 32 rendered to the user 108.

In the example illustrated, the apparatus 10 is configured to temporarily modify 140 the audio cancellation process 34 applied to captured ambient audio 30 according to different options which can be performed individually or in different combinations.

According to the first option (i), the apparatus 10 is configured 132 to temporarily reduce audio cancellation for higher frequencies compared to lower frequencies to enable the user 108 to hear the sound 104 of the sound-producing user gesture 106. A high band pass filter can be used.

According to the second option (ii), the apparatus 10 is configured 134 to temporarily increase transparency to ambient audio by reducing attenuation of captured ambient audio 30 to enable the user 108 to hear a sound 104 of the sound-producing user gesture 106. A time-variable loudness filter can be used.

According to the third option (iii), the apparatus 10 is configured 136 to temporarily switch-off audio cancellation 34 to enable the user 108 to hear the sound 104 of the sound-producing user gesture 106.

According to the fourth option (iv), the apparatus 10 is configured 138 to temporarily provide spatially selective pass-through of an ambient audio source by selectively maintaining the ambient spatial audio source in the captured ambient audio 30 to enable the user 108 to hear a sound of the sound-producing user gesture 106.

In this example, the apparatus 10 is configured to enable a user to control 150 the temporary modifying 140 of the audio cancellation process 34 applied to captured ambient audio 30. For example, in some examples, the user control 150 enables a user to select whether one or more of the first, second, third or fourth options are used for temporarily modifying 140 the audio cancellation process 34 applied to captured ambient audio 30.

In the example illustrated, the apparatus 10 is configured for user control 150 of which one or more of the different options is/are performed to temporarily modify 140 the audio cancellation process 34 applied to captured ambient audio 30.

In some examples, the apparatus 10 is configured for user control 150 of parameters used for the selected option(s). For example, in some examples of option (i), the user control 150 is used to control the frequencies that are attenuated and/or the frequencies that are not attenuated. For example, in some examples of option (ii), the parameters of transparency are controlled. For example, in some examples of option (iv), the parameters of spatially-selective pass-through are controlled.

FIG. 5 illustrates an example of any of the apparatus 10 previously described. FIG. 5 illustrates an example where the apparatus 10 is configured to provide audio feedback 120 to the user 108, using a virtual sound 164, in dependence upon the classification 111. In this example, the apparatus 10 is configured 160 to temporarily render to the user 108 a virtual sound 164.

The apparatus 10 comprises an audio feedback module 120 configured to provide audio feedback to the user in dependence upon the classification 111. The audio feedback module 120 comprises a modifying module 140, an audio cancellation module 130 configured to apply audio cancellation to captured ambient audio 30 to create ambient audio 32 and a virtual sound module 160 configured to add a virtual sound 164 to the created ambient audio 32.

The modifying module 140 is configured to control audio feedback to the user in dependence upon the classification 111.

The modifying module 140 is configured to control the audio cancellation process 34 in dependence upon the classification 111. The modifying module 140 is configured to temporarily modify the audio cancellation process 34 applied to captured ambient audio 30 as previously described.

In this example, the modifying module 140 is configured to control addition of a virtual sound 164 to the created ambient audio 32 in dependence upon the classification 111.

In some but not necessarily all examples, the modifying module 140 controls whether or not a virtual sound 164 is rendered. For example, the virtual sound 164 is rendered only if, when the created ambient audio 32 is rendered to the user, a sound of the sound-producing user gesture in the created ambient audio 32 rendered to the user 108, would be below a loudness threshold.

In the illustrated example, the modifying module 140 is configured to select the virtual sound 164 from a database 162 of virtual sounds in dependence upon the classification 111. For example, the virtual sound 164 is selected, in dependence upon the classification 111, to mimic the class of sound-producing user gesture determined by the classification 111.

In this example, the apparatus 10 is configured to enable a user to control 150 the extent to which the provision of audio feedback 120 to the user in dependence upon the classification 111 is based upon: modifying 140 the audio cancellation process 34 applied to captured ambient audio 30 to create ambient audio 32 rendered to the user 108; and rendering a virtual sound 164 to the user. For example, in some examples, the user control 150 enables a user to select more immersion and this results in rendering a virtual sound 164 to the user. For example, in some examples, the user control 150 enables a user to select less immersion and this results in no rendering of a virtual sound 164 to the user but modifying 140 the audio cancellation process 34 applied to captured ambient audio 30 to allow pass-through of more ambient sound.

FIGS. 6A and 6B illustrate an example of operation of any of the apparatus 10 previously described.

As illustrated in FIG. 6A, the apparatus 10 is configured to determine a direction 161 towards the sensed user movement 102 classified as a sound-producing 104 user gesture 106. This can, for example, be achieved using a microphone array and measuring a time-lag for sound from the sound-producing 104 user gesture 106 to reach the different microphones in the microphone array.

As illustrated in FIG. 6B, the apparatus 10 is configured to provide audio feedback 120 to the user in dependence upon the classification 111 that is aligned with the determined direction 161. For example, the virtual sound 164 can be positioned so that it is aligned with the determined direction 161.

In the preceding examples, the apparatus 10 is configured to conditionally provide audio feedback 120 to the user. It provides audio feedback 120 to the user if the user movement 102 is classified based upon at least the sensing data 101 as a sound-producing 104 user gesture 106 and does not provide audio feedback 120 to the user 108 if the user movement 102, is not classified based upon at least the sensing data 101 as a sound-producing 104 user gesture 106.

The classification of user movement 102, based upon at least the sensing data 101 as a sound-producing 104 user gesture 106 can be achieved in any suitable way based on sensing data 101 from a single sensor or from multiple sensors.

In at least some examples, the classification uses a trained machine learning classification algorithm 112 such as a neural network or support vector machine or k-nearest neighbours, naïve bayes for example. The machine learning classification algorithm can, for example, be a binary classification algorithm (is there a sound-producing 104 user gesture 106 or not). The machine learning classification algorithm can, for example, be multi-class classification algorithm (what is the sound-producing 104 user gesture 106?).

In one implementation and use case the apparatus 10 operates as audio gesture transparent headphones. Audio feedback allows a user to know if a sound-generating gesture 106 has been successful.

The head-worn apparatus comprises a gesture detecting sensor and noise cancelling headphones where the noise cancellation or an audio user interface (UI) is controlled when it is detected that a sound producing gesture is about to take place. The apparatus 10 could be an augmented reality, virtual reality, or mixed reality (AR/VR/MR) headset. The gesture detection sensor may be a camera or other sensor such as lidar.

The apparatus 10 detects that a sound gesture 106 is imminent from hand pose in finger-snapping case or from open hands moving towards each other in a hand-clapping case. The apparatus 10 uses camera or other sensor and processing to do the detection. The apparatus can, for example, comprise the sensor (e.g. camera) or can receive sensor data (e.g. camera feed) from some other device, for example from a mobile phone.

The apparatus 10 on detecting that a sound gesture 106 is imminent, turns active noise cancellation (ANC) off and/or switches on a pass-through mode in the headphones so that user can hear the sound gesture 106. The apparatus 10 uses camera or other sensors and/or microphones to detect if the sound gesture has been finalized (finished) and then returns to previous operation e.g. turns ANC back on and/or switches off the new pass-through mode in the headphones.

The apparatus 10 can correlate sound from microphones to other sensor data to see if the sound 104 and movement 102 occurred at the same time to make gesture 106 detection more robust in the presence of background noise.

The apparatus 10 can be configured to modify ANC and pass-through operation so that instead of passing all frequencies through during the sound gesture 106, the headphones only pass through high frequencies (typically 1 kHz and above, but the low frequency limit may be anything from about 50 Hz-2 kHz). Sound gestures 106 are typically impulses that contain almost all frequencies. Therefore, sound gestures are easily recognizable even when high pass filtered. Letting only high frequencies pass through keeps the most important functionality of ANC still operational, that is removing low frequency noises. Thus, the desired operation for letting high frequencies pass during sound gesture could be achieved by keeping ANC operation normal but turning pass-through operation on at the same time.

If the gesture 106 was successful, but the sound 104 from the gesture was more quiet than usual (below a threshold), the apparatus may play a confirmation sound (virtual sound 164) to the user 108 that may be any sound but may also be a sound that mimics the detected gesture sound 104. The apparatus 10 can have a database 162 of gesture sounds (virtual sound 164) and can chooses the right one from the database 162. In this way the user gets a non-disturbing confirmation of the gesture success. The added sound (virtual sound 164) may be spatial so that it appears to be coming from the direction 161 of the detected gesture 106. The direction 161 can be detected using the camera or other sensor.

In some embodiments the headset (apparatus 10) allows control for the level of immersion. The same control can be used to control how much the user is played a virtual sound 164 or real pass-through sound of the user gesture 106. If the control is set for more immersion, the pass-through mode is not used much and instead the user is played a virtual finger snapping or hand clapping sound (virtual sound 164). If the control is set for more real-world then the pass-through mode is activated more, and user is played less virtual sound 164. The control may be gradual between two extremes where only pass-through or virtual sound 164 is used. The virtual sound 164 may take into account the virtual world sound characteristics such as frequency response, impulse response and echo and use these to modify the virtual sound 164 so that it matches better other sounds played in the virtual world.

In the preceding examples, the focus has been on the local rendering of ambient audio to a first user where the ambient audio includes sounds 104 created by performance (user movement 102) of a gesture 106 by the first user 108. In these examples, all or part of the sound 104 created by performance of the gesture 106 by the first user 108 is passed through to the first user and/or a virtual sound 164 is rendered to the first user in addition to any other ‘base’ ambient audio or audio content for the first user.

In some circumstances it is desirable to render ambient audio that is local to the first user remotely from the first user for example to a second user. In this example, only the ‘base’ ambient audio and audio content for the second user is provided. The pass-through audio (all or part of the sound 104 created by performance (user movement 102) of the gesture 106 by the first user 108) is not provided. The virtual sound 164 is not provided.

In some examples, the audio content for the first user (first audio content, first audio content information 40) comprises captured speech of the second user and the audio content for the second user (second audio content, second audio content information 42) comprises captured speech of the first user.

As illustrated in FIGS. 7 & 8, the apparatus 10 can therefore be configured to apply a second audio cancellation process 38 on captured ambient audio 30 to create ambient audio for remote rendering; and applying an audio cancellation process 34 on captured ambient audio 30 to create ambient audio for local rendering to the user. The second audio cancellation process 38 and the audio cancellation process 34 can be the same in the absence of a sound-producing 104 user gesture 106 by the user 108. However, when there is a sound-producing 104 user gesture 106, the apparatus 10 is configured to provide additional audio feedback 120 to the user 108 in dependence upon the classification 111 of the sensing data 101. This involves temporarily modifying the audio cancellation process 34 applied to captured ambient audio 30 to create ambient audio for local rendering to the user 108.

FIG. 7 illustrates an example of the apparatus 10 for rendering audio to a local user (not illustrated).

The apparatus 10 comprises: means 20 for capturing ambient audio 30; means for applying an audio cancellation process 34 to the captured ambient audio 30 to create first user ambient audio 32; means 18 for rendering 19 first user ambient audio 32 and means 18 for rendering 19 first audio content 40.

FIG. 8 illustrates an example of the apparatus 10 operating to cause or enable rendering of audio to a remote user (not illustrated).

The apparatus 10 comprises: means for providing to a remote apparatus 300 at least first user ambient audio information 36 and first user content information 42 to enable remote rendering 319 of the first audio content 40 and at least some of the first user ambient audio 32. The remote rendering is via one or more speakers 318.

In some examples, the apparatus 10 enables remote rendering 319 of the first user ambient audio 32. That is the first user ambient audio 32 that is rendered locally 19 is the same as that rendered remotely 319.

In other examples, the apparatus 10 enables remote rendering 319 of a reduced version of the first user ambient audio 32. That is the first user ambient audio 32 that is rendered locally 19 has content, the audio feedback, that is not present in what is rendered remotely 319.

The apparatus 10 comprises: means 20 for capturing ambient audio 30 and means for applying a second audio cancellation process 38 to the captured ambient audio 30 to create first user ambient audio information 36.

In the absence of a sound-producing 104 user gesture 106, the second audio cancellation process 38 is the same as the audio cancellation process 34. This provides remote rendering 319 of the first user ambient audio 32. That is, the first user ambient audio 32 that is rendered locally 19 is the same as that rendered remotely 319.

When there is a sound-producing 104 user gesture 106, the second audio cancellation process 38 is the different to the audio cancellation process 34. This provides first user ambient audio 32 that is rendered locally 19 that is different to what is rendered remotely 319 because it includes additional feedback.

In some but not necessarily all examples, the first audio cancellation process 34 is configured to disambiguate audio sources in the captured ambient audio 30 and to apply different cancellation processes to audio of different audio sources.

This can be used to selectively remove audio sources from the captured ambient audio 30. For example, the audio source that represents a voice of a first user 108 of the apparatus 10 can be removed from the captured ambient audio 30.

This can be used to selectively keep or enhance audio sources in the captured ambient audio 30. For example, the audio source that represents a sound-producing 104 user gesture 106 can be maintained in original or modified form in the captured ambient audio 30. Thus, there is audio pass-through (or audio transparency).

The audio cancellation process 34 and the second audio cancellation process 38 can be configured to apply different cancellation processes to audio of different audio sources.

When there is a sound-producing 104 user gesture 106, a first audio cancellation process 34 is applied to the captured ambient audio 30 to create first user ambient audio 32 for rendering to a local first user 108, and a second audio cancellation process 38 is applied to the captured ambient audio 30 to create remote user ambient audio for remote rendering 319 to a remote user 302. The second audio cancellation process 38 is different to the first audio cancellation process 34 and is configured to cancel audio in addition to that cancelled by the first audio cancellation process 34.

For example, the audio source that represents sound-producing 104 user gesture 106 can be maintained in the captured ambient audio 30 by the first audio cancellation process 34 and removed by the second audio cancellation process 38.

In at least some examples, the first audio cancellation process 34 is prioritized over the second audio cancellation process 38. This can be used to avoid a delay in the first audio cancellation process 34. The prioritization can be by allocation of resources in parallel or by temporal ordering. In at least some examples, the second audio cancellation process 38 is performed after the first audio cancellation process 34.

In at least some examples, the first audio cancellation process 34 is specific to the form of local rendering 19 performed whereas the second audio cancellation process 38 is not specific to the form of local rendering 19 performed.

In FIGS. 7 and 8, the ambient audio is captured by one or more microphones 20 as captured ambient audio 30. Although the capturing of the ambient audio is illustrated separately in FIGS. 7 and 8, in at least some examples a single audio capture process can capture the ambient audio used in FIGS. 7 and 8. Thus the captured ambient audio 30 in FIGS. 7 and 8 can be the same.

In at least some examples, the first audio content 40 is spatial audio content and the first user content information 42 enables the rendering of the spatial first audio content 40.

Spatial audio describes the rendering of sound sources at different controllable directions relative to a first user. The user can therefore hear the sound sources as if they are arriving from different directions. A spatial audio service controls or sets at least one directional property of at least one sound source. The directional properties are properties that can be defined independently for different directions and can for example include relative intensity of the sound source, size of the sound source, distance of the sound source, or audio characteristics of the sound source such as reverberation, spectral filtering etc.

Various audio formats can be used for spatial audio. Examples include multi-channel mixes (e.g., 5.1, 7.1+4), Ambisonics (FOA/HOA), parametric spatial audio (e.g., Metadata-assisted spatial audio-MASA, which has been proposed in context of 3GPP IVAS codec standardization), object-based audio, and any suitable combinations thereof.

In some examples, spatial audio is rendered to a first user via a head-mounted apparatus (a headset). The rendered sound sources can be positioned relative to the real-world or positioned relative to the headset.

Positioning of sound sources relative to the headset, does not require any tracking of movement of the headset.

Positioning of sound sources relative to the real-world does require tracking of movement of the headset. If a point of view defined for the headset rotates to the right, then the sound scene comprising the sound sources needs to rotate to the left so that it remains fixed in the real-world (world-fixed).

The point of view can be defined by orientation or by orientation and location. Where the point of view is defined by three-dimensional orientation it is described as 3DoF (three degrees of freedom). Where the point of view is defined by three-dimensional orientation and by three-dimensional location it is described as 6DoF (six degrees of freedom). Where the point of view is defined by three-dimensional orientation and by only limited movement such as leaning, it is described as 3DoF+ (three degrees of freedom plus).

Thus, without head-tracking a sound scene remains fixed to the user's head when the user rotates their head, and with head-tracking the sound scene rotates relative to user's head, when user rotates their head, in a direction opposite to the user's head rotation so that sound sources appear fixed in space.

Not all audio services are spatial audio services. For example, an audio service can provide monophonic audio or stereo audio.

FIG. 9 illustrates an example of an apparatus 10.

In this example, the apparatus 10 is configured as a head-worn apparatus that is worn by a first user 108. In this example, the apparatus 12 is configured as a head-worn apparatus 12, optionally an in-ear apparatus 12, an on-ear apparatus 12 or an over-ear apparatus 12.

In this example, the apparatus 10 is configured as a local apparatus 500, local to the first user 108, which is used to provide a communication pathway 510 between the head-worn apparatus 12 and the remote apparatus 300. In this example, the communication pathway 510 is wireless.

The local apparatus 500 can in at least some examples provide additional processing resources not available in the head-worn apparatus 12.

In some examples, the head-worn apparatus 12 is configured to perform the first audio cancellation process 34 and the second audio cancellation process 38.

In some examples, the head-worn apparatus 12 is configured to perform the first audio cancellation process 34 and the local apparatus 500 is configured to perform the second audio cancellation process 38.

In some examples, the local apparatus 500 is configured to perform the first audio cancellation process 34 and the second audio cancellation process 38.

In this example, the apparatus 12 comprises means 14 for rendering 19, to a first user 108, first user ambient audio 32 and means 14 for rendering 19, to the first user 108, first audio content 40.

The head-worn apparatus 12 comprise a left-ear part 14 and a right ear part 14. Each of the parts 14 comprises one or more speakers 18 associated with a cavity 16 formed between the first user's ear and audio isolation 15 which creates a sound barrier. The cavity 16 can be described as an interior cavity as it is an enclosed cavity formed between the apparatus 12 and the first user. The one or more speakers 18 are used for rendering 19 of audio in the interior cavity 16.

The head-worn apparatus 12 also comprises means 20 for capturing ambient audio 30 such as one or more exterior microphones on an exterior portion of the parts 14. The ambient audio is external to the head-worn apparatus 12. It is the sound in the environment external to the apparatus 12.

Multiple exterior microphones can be used to capture spatial audio as an exterior sound scene comprising multiple spatially located sound sources.

In some examples, the head-worn apparatus 12 also comprises means for capturing audio within the cavity 16, such as interior microphones.

In some examples, the exterior microphones and/or the interior microphones can be used for active noise cancellation ANC.

Active noise cancellation (ANC) estimates the noise that would reach a listener's ear and adapts the audio output signals to cancel that estimated noise. The noise can be estimated using a feed-forward approach that uses one or more noise signals measured using one or more exterior microphones on the same ear device and/or using a feed-back approach that uses one or more noise signals measured using one or more interior microphones of the same ear device.

In some examples, the first audio content 40 is spatial audio content configured for rendering via a left-ear part 14 and a right ear part 14. For example, the first audio content 40 can be binaural encoded.

In some examples, a local apparatus 500 is configured to communicate 510 with the head-worn apparatus 12 via a radio transceiver, for example, a Bluetooth or WIFI transceiver.

In some examples, the local apparatus 500 is configured to communicate with the remote apparatus 300 either directly or indirectly via a network 200. In some examples, the local apparatus 500 comprises a radio transceiver, for example, a cellular or WIFI transceiver for such communication.

The local apparatus 500 can therefore comprise means for providing to remote apparatus 300 at least first user ambient audio information 36; and first user content information 42 to enable remote rendering 319 of first user content and first user ambient audio 32 to a remote user.

In some examples, the local apparatus 500 comprises means 14 for rendering 19, to a first user 108, first user ambient audio 32 and first audio content 40 such as one or more speakers.

In some examples, the local apparatus 500 comprises means for capturing ambient audio 30 such as one or more exterior microphones. Multiple exterior microphones can be used to capture an exterior sound scene comprising multiple spatially located sound sources.

FIG. 10 illustrates an example of a method 600. The method 600 provides audio feedback a user in dependence upon the classification of sensing data. In at least some examples, the method 600 is a computer-implemented method.

The method 600 comprises, at block 602, sensing a user movement, wherein the sensing of the user movement produces sensing data.

The method 600 comprises, at block 604, classifying the user movement, in dependence upon at least the sensing data, as a sound-producing user gesture.

The method 600 comprises, at block 606, providing audio feedback 120 to the user in dependence upon the classification 111.

FIG. 11 illustrates an example of a controller 700 suitable for use in an apparatus 10, 12, 500. Implementation of a controller 700 may be as controller circuitry. The controller 700 may be implemented in hardware alone, have certain aspects in software including firmware alone or can be a combination of hardware and software (including firmware).

As illustrated in FIG. 11 the controller 700 may be implemented using instructions that enable hardware functionality, for example, by using executable instructions of a computer program 706 in a general-purpose or special-purpose processor 702 that may be stored on a computer readable storage medium (disk, memory etc.) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus 10 when loaded into the processor 702. The computer program instructions, of the computer program 706, provide the logic and routines that enables the apparatus to perform the methods illustrated in the accompanying Figs. The processor 702 by reading the memory 704, is able to load and execute the computer program 706.

The apparatus 10 comprises:
at least one processor 702; and
at least one memory 704 including computer program code,
the at least one memory storing instructions that, when executed by the at least one processor 702, cause the apparatus at least to perform:
classifying a sensed use movement, in dependence upon at least sensing data, as a sound-producing user gesture; and
providing audio feedback 120 to the user in dependence upon the classification 111.

As illustrated in FIG. 12, the computer program 706 may arrive at the apparatus 10 via any suitable delivery mechanism 708. The delivery mechanism 708 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 706. The delivery mechanism may be a signal configured to reliably transfer the computer program 706. The apparatus 10 may propagate or transmit the computer program 706 as a computer data signal.

Computer program instructions for causing an apparatus to perform at least the following or for performing at least the following:
classifying a sensed use movement, in dependence upon at least sensing data, as a sound-producing user gesture; and
providing audio feedback 120 to the user in dependence upon the classification 111.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 706. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

As used here ‘module’ refers to a unit or apparatus that excludes certain parts/components that would be added by an end manufacturer or a user. The controller 700 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1-17. (canceled)

18. An apparatus comprising:
at least one processor; and
at least one memory storing instructions that, when executed by the at least one processor, cause the apparatus at least to:
sense user movement, wherein the sensing of user movement produces sensing data;
classify the user movement, in dependence upon at least the sensing data, as a sound-producing user gesture of a user; and
provide audio feedback to the user in dependence upon the classification.

19. An apparatus as claimed in claim 18, wherein providing audio feedback to the user in dependence upon the classification comprises temporarily modifying an audio cancellation process applied to captured ambient audio to create ambient audio for rendering to the user.

20. An apparatus as claimed in claim 19, wherein temporarily modifying the audio cancellation process applied to captured ambient audio comprises selectively filtering the ambient audio.

21. An apparatus as claimed in claim 19, wherein temporarily modifying the audio cancellation process applied to captured ambient audio comprises at least one of:
(i) temporarily reducing audio cancellation for higher frequencies compared to lower frequencies to enable the user to hear a sound of the sound-producing user gesture;
(ii) temporarily reducing attenuation of captured ambient audio to enable the user to hear a sound of the sound-producing user gesture;
(iii) temporarily switching-off audio cancellation to enable the user to hear a sound of the sound-producing user gesture; or
(iv) providing spatially selective pass-through of an ambient audio source by selectively maintaining the ambient spatial audio source in the captured ambient audio to enable the user to hear a sound of the sound-producing user gesture.

22. An apparatus as claimed in claim 19, wherein the apparatus is further caused to enable a user to control the modification of the audio cancellation process applied to captured ambient audio.

23. An apparatus as claimed in claim 18, wherein providing audio feedback to the user in dependence upon the classification comprises temporarily rendering to the user a virtual sound.

24. An apparatus as claimed in claim 19, wherein providing audio feedback to the user in dependence upon the classification comprises temporarily rendering to the user the virtual sound only if, when the created ambient audio is rendered to the user, a sound of the sound-producing user gesture in the created ambient audio rendered to the user, is below a loudness threshold.

25. An apparatus as claimed in claim 23, wherein the virtual sound is a sound selected from a database of virtual sounds in dependence upon the classification.

26. An apparatus as claimed in claim 23, wherein the virtual sound is a sound selected from a database of virtual sounds in dependence upon the classification.

27. An apparatus as claimed in claim 19, wherein the apparatus is further caused to enable a user to control the extent to which the provision of audio feedback to the user in dependence upon the classification is based upon:
modifying the audio cancellation process applied to captured ambient audio to create ambient audio rendered to the user; and
rendering to the user a virtual sound.

28. An apparatus as claimed in claim 18, wherein the apparatus is further caused to determine a direction towards the sensed user movement classified as a sound-producing user gesture; and
wherein providing audio feedback to the user in dependence upon the classification comprises providing audio feedback as spatial audio aligned with the determined direction.

29. An apparatus as claimed in claim 18, wherein providing the audio feedback to the user is configured for conditional operation and provides audio feedback to the user if the user movement is classified based upon at least the sensing data as a sound-producing user gesture and does not provide audio feedback to the user if the user movement, is not classified based upon at least the sensing data as a sound-producing user gesture.

30. An apparatus as claimed in claim 18, wherein the apparatus is further caused to classify the user movement, in dependence upon at least the sensing data using a trained machine learning classification algorithm.

31. An apparatus as claimed in claim 18, wherein the apparatus comprises an optical sensor for sensing user movement.

32. An apparatus as claimed in claim 18, wherein the apparatus is further caused to:
apply a first audio cancellation process on captured ambient audio to create ambient audio for remote rendering; and
apply the first audio cancellation process on captured ambient audio to create ambient audio for local rendering to the user;
wherein providing audio feedback to the user in dependence upon the classification comprises temporarily modifying the first audio cancellation process applied to captured ambient audio to create ambient audio for local rendering to the user.

33. A method comprising:
sensing a user movement, wherein the sensing of the user movement produces sensing data;
classifying the user movement, in dependence upon at least the sensing data, as a sound-producing user gesture of a user; and
providing audio feedback to the user in dependence upon the classification.

34. A method as claimed in claim 33, wherein providing audio feedback to the user in dependence upon the classification comprises temporarily modifying an audio cancellation process applied to captured ambient audio to create ambient audio for rendering to the user.

35. A method as claimed in claim 34, wherein temporarily modifying the audio cancellation process applied to captured ambient audio comprises at least one of:
(i) selectively filtering the ambient audio;
(ii) temporarily reducing audio cancellation for higher frequencies compared to lower frequencies to enable the user to hear a sound of the sound-producing user gesture;
(iii) temporarily reducing attenuation of captured ambient audio to enable the user to hear a sound of the sound-producing user gesture;
(iv) temporarily switching-off audio cancellation to enable the user to hear a sound of the sound-producing user gesture; or
(v) providing spatially selective pass-through of an ambient audio source by selectively maintaining the ambient spatial audio source in the captured ambient audio to enable the user to hear a sound of the sound-producing user gesture.

36. A method as claimed in claim 34, further comprising enabling a user to control the modification of the audio cancellation process applied to captured ambient audio.

37. A non-transitory computer readable medium comprising program instructions stored thereon for performing at least the following:
classifying a sensed user movement, in dependence upon at least sensing data, as a sound-producing user gesture of a user; and
providing audio feedback to the user in dependence upon the classification.
